(19) United States
(12) Patent Application Publication
(10) Pub. No.: US 2026/0100885 A1
(43) Pub. Date: Apr. 9, 2026

(54) METHOD OF DETERMINING ERROR TERMS OF A DEVICE ARRANGEMENT, MEASURING ARRANGEMENT AND PERMANENT STORAGE MEDIUM

(71) Applicant: Rohde & Schwarz GmbH & Co. KG, Muenchen (DE)

(72) Inventors: Julius SEEGER, Muenchen (DE); Philipp KURPIERS, Muenchen (DE)

(21) Appl. No.: 19/311,617

(22) Filed: Aug. 27, 2025

(30) Foreign Application Priority Data
Oct. 8, 2024 (DE) 10 2024 128 978.3

(51) Int. Cl. H04L 41/14; H04L 41/0631; H04L 43/50

(52) U.S. Cl. CPC H04L 41/14; H04L 41/0631; H04L 43/50

(57) ABSTRACT

A method of determining error terms of a device arrangement by a vector network analyzer (VNA) is described. The device arrangement includes a first connection circuit and a second connection circuit having negligible reverse transmission. The method includes connecting a known first calibration standard to a second connector of the first connection circuit and to a first connector of the second connection circuit; generating a test signal by the VNA and outputting the test signal; measuring a transmission signal obtained; repeating the above steps for two further known calibration standards; and determining error terms of the device arrangement based on the signals measured, the error terms describing a signal transmission behavior of the device arrangement.

### CROSS-REFERENCE(S) TO RELATED APPLICATION(S)

This application claims priority to German Patent Application No. 10 2024 128 978.3, filed on Oct. 8, 2024, the entire disclosure of which is included herein in its entirety.

### FIELD OF THE DISCLOSURE

Embodiments of the present disclosure generally relate to a method of determining error terms of a device arrangement by a vector network analyzer. Embodiments of the present disclosure further relate to a measuring arrangement and a permanent storage medium.

### BACKGROUND

In measurements using a vector network analyzer, it is customary to perform a calibration of a device arrangement which provides the electrical connections to a device under test. However, when using known calibration methods, not all error terms of a device arrangement can be determined at all events, for example, if reverse transmissions are greatly suppressed in each of a transmit path and a receive path of the device arrangement.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

An object of the present disclosure, among others, is to provide a calibration method, a measuring arrangement and a permanent storage medium which allow reliable calibration for a multitude of device arrangements.

The object set forth above is achieved according to the disclosed technology by a method of determining error terms of a device arrangement by a vector network analyzer (VNA). The VNA includes a first VNA connector and a second VNA connector. The device arrangement includes a first connection circuit and a second connection circuit, the first connection circuit and the second connection circuit each including a first connector and a second connector. The first connection circuit and the second connection circuit each have negligible reverse transmission. In an embodiment, the method includes:
(a) connecting the first connector of the first connection circuit to the first VNA connector;
(b) connecting the second connector of the second connection circuit to the second VNA connector;
(c) connecting a known first calibration standard to the second connector of the first connection circuit and to the first connector of the second connection circuit;
(d) generating a test signal by the VNA and outputting the test signal through the first VNA connector;
(e) measuring a transmission signal obtained from the second VNA connector;
(f) repeating the actions of connecting a known first calibration standard to the second connector of the first connection circuit and to the first connector of the second connection circuit, generating the test signal by the VNA and outputting the test signal through the first VNA connector, and measuring the transmission signal obtained from the second VNA connector, for two further known calibration standards;
(g) generating a test signal by the VNA, outputting the test signal through the first VNA connector, and measuring a reflection signal obtained from the first VNA connector;
(h) generating a test signal by the VNA, outputting the test signal through the second VNA connector, and measuring a reflection signal obtained from the second VNA connector; and
(i) determining error terms of the device arrangement based on the signals measured, the error terms describing a signal transmission behavior of the device arrangement.

It will be appreciated that in place of the term “VNA connector”, the term “VNA gate” is also commonly used.

The known calibration standards are each calibration standards for transmission measurements, which are usually also referred to as “through” calibration standards.

The first connection circuit and the second connection circuit each have negligible reverse transmission. This should be understood to mean that a signal that travels forward through the respective connection circuit is significantly less attenuated and/or significantly more amplified than a signal that travels backward through the respective connection circuit.

Here, an attenuation experienced by a signal traveling from the second connector of the first connection circuit toward the first VNA connector is greater than an attenuation experienced by a signal traveling from the first connector of the second connection circuit toward the second VNA connector, for example by a predefined factor.

Furthermore, an attenuation experienced by a signal traveling from the first connector of the second connection circuit toward the second VNA connector is smaller than an attenuation experienced by a signal traveling from the second VNA connector toward the first connector of the second connection circuit, for example by a predefined factor.

In an embodiment, the predefined factor is, for example, greater than or equal to 10, greater than or equal to 50, greater than or equal to 100, greater than or equal to 1000, or greater than or equal to 10000.

This is the case, for example, in cryostats for quantum computer chips, in which strong attenuation is provided in the first connection circuit in order to minimize energy input into the cryostat. A reflected signal therefore passes through this strong attenuation twice, so that a signal level of the signal traveling backward typically disappears in the background noise. In the second connection circuit, a plurality of cascaded amplifiers, for example a plurality of cascaded low-noise amplifiers, are typically provided here, which amplify a forward-traveling signal again for later analysis. These amplifiers, however, do not allow reverse transmission or at least do not amplify it.

A low-noise amplifier as used herein is understood to include an amplifier having a noise factor of less than 5 dB.

A further example of such a device arrangement with negligible reverse transmission is a device arrangement having one or more high-power amplifiers in the first connection circuit and one or more amplifiers in the second connection circuit, for example one or more low-noise amplifiers in the second connection circuit.

The method according to embodiments of the disclosure makes it possible to determine the error terms of the device arrangement and thus to calibrate the device arrangement for later measurements on a device under test.

In contrast to methods known from the prior art, the method according to embodiments of the disclosure allows the error terms to be determined also for device arrangements with negligible reverse transmission.

In an embodiment, the error terms can be determined here based on a suitable error term model of the device arrangement, as will be discussed in more detail below.

Actions (g) and (h) can be performed, for example, while one of the three known calibration standards is in the installed state.

According to an aspect of the disclosure, a frequency of the generated test signal or signals is varied. This allows the device arrangement to be calibrated for a predefined frequency range over which the frequencies of the generated test signal or signals extend.

In an embodiment, the frequency is varied continuously or in predetermined steps over the predefined frequency range, which is also referred to as a frequency sweep.

According to a further aspect of the disclosure, the error terms, for example, are determined based on a linear error term model. In an embodiment, the linear error term model is a respective reverse transmission of the first connection circuit and the second connection circuit are set equal to zero. In other words, the negligible reverse transmissions of the first connection circuit and the second connection circuit are thus taken into account in the linear error term model by setting the respective error terms equal to zero. This allows the remaining error terms that describe the device arrangement to be determined based on the measurements described above.

In an embodiment, the first connection circuit includes an amplifier arrangement configured to amplify signals from the first connector toward the second connector. For example, the amplifier arrangement includes a high-power amplifier or a low-noise amplifier. More specifically, the amplifier arrangement is only configured to amplify the signals from the first connector toward the second connector, but not from the second connector toward the first connector. As a result, reverse transmission of the first connection circuit is negligible. The representative methods according to the disclosure allow calibration of such device arrangements.

In a further configuration of the disclosure, the first connection circuit includes an attenuation arrangement, wherein an attenuation provided by the attenuation arrangement is greater than half the dynamic range of the VNA. A forward-traveling signal is therefore attenuated by the attenuation arrangement with an attenuation that is greater than half the dynamic range of the VNA. A corresponding backward-traveling signal is attenuated a second time with this attenuation, so that the backward-traveling signal experiences an overall attenuation that is greater than the dynamic range of the VNA. Accordingly, the backward-traveling signal arriving at the VNA has a signal level that is in the background noise. The reverse transmission of the first connection circuit is therefore negligible. The method according to embodiments of the disclosure allows calibration of such device arrangements.

The dynamic range of the VNA should be understood to mean a level range used by the VNA in the measurement settings used, for example of the frequency and the level of the test signal as well as the integration bandwidth used of the receiving VNA connector. In VNAs, the integration bandwidth is typically referred to as IFBW (intermediate frequency bandwidth). With a higher IFBW, the dynamics of the VNA will decrease. The dynamics will also decrease when the level of the test signal output at the VNA connector is reduced. In other words, in the present disclosure, the dynamic range of the VNA should therefore not necessarily be understood as the maximum possible dynamics of the VNA as specified, e.g., in the data sheet.

In an embodiment, the VNA may have a dynamic range of 150 dB, for example. The attenuation arrangement may, for example, provide an attenuation of more than 75 dB, for example of more than 80 dB.

One aspect of the disclosure provides, for example, that the second connection circuit includes an amplifier arrangement. In an embodiment, the amplifier arrangement is configured to amplify signals from the first connector toward the second connector, for example wherein the amplifier arrangement includes an amplifier. More specifically, the amplifier arrangement is only configured to amplify the signals from the first connector toward the second connector, but not from the second connector toward the first connector. As a result, the reverse transmission of the first connection circuit is negligible or even blocked.

In an embodiment, the amplifier arrangement includes at least one low-noise amplifier. For example, the amplifier arrangement includes a plurality of cascaded amplifiers, for example a plurality of cascaded low-noise amplifiers.

In an embodiment, the amplifier arrangement may include at least one isolator that allows signal propagation only in the forward direction. More specifically, the amplifier arrangement of the first connection circuit may include at least one isolator, for example in combination with at least one low-noise amplifier.

Alternatively or additionally, the amplifier arrangement of the second connection circuit may include at least one isolator, for example in combination with at least one low-noise amplifier.

In an embodiment, the amplifier arrangement may include a plurality of cascaded isolators which allow signal propagation only in the forward direction.

According to one aspect of the disclosure, the three known calibration standards, for example, are different from each other. Alternatively, the second known calibration standard corresponds to the first calibration standard in a reverse mounting direction and the third known calibration standard is different from the first calibration standard and from the second calibration standard. Alternatively, the second known calibration standard corresponds to the first calibration standard in a reverse mounting direction and the third known calibration standard corresponds to a series connection of two first known calibration standards.

In an embodiment, three calibration standards that are different from each other can therefore be used. For example, the three known calibration standards may be three different pieces of line. In an embodiment, the three different pieces of line have different lengths and/or different cross-sections.

In an embodiment, the first known calibration standard and the second calibration standard may be the same calibration standard. However, the second calibration standard is used in a reverse mounting direction. The third calibration standard may be different from the first calibration standard and therefore also from the second calibration standard. In this variant, reductions are obtained in a system of equations that needs to be solved to determine the error terms.

In an embodiment, the first known calibration standard and the second known calibration standard are the same calibration standard. However, the second calibration standard is used in a reverse mounting direction. The third known calibration standard corresponds to a series connection of two identically designed first calibration standards. In this variant, further reductions are obtained in a system of equations that needs to be solved to determine the error terms.

In an embodiment, the device arrangement includes a cryostat, the first connection circuit and the second connection circuit being arranged within the cryostat. For example, the cryostat is a cryostat for a quantum computer. In this case, the first connection circuit thus includes the lead-in wires for a quantum computer chip, while the second connection circuit includes the lead-out wires for the quantum computer chip.

In order to minimize energy input into the cryostat, the first connection circuit typically has a strong attenuation, as described above. The second connection circuit typically includes one or more cascaded amplifiers, for example one or more cascaded low-noise amplifiers, to amplify readout signals of the quantum computer chip.

In an embodiment, the cryostat is, for example, a dilution refrigerator.

In an embodiment, the known calibration standards are connected inside the cryostat to the second connector of the first connection circuit and to the first connector of the second connection circuit. The measurements on the calibration standards are thus carried out under the same temperature conditions to which a device under test is subjected in the cryostat.

Accordingly, it may be provided, after installation of the respective calibration standard, to cool the interior of the cryostat to the operating temperature of the device under test. After the operating temperature of the device under test has been reached, the calibration steps described above can be carried out.

In an embodiment, the device arrangement may include a permanent storage medium, the error terms determined being saved in the permanent storage medium. Typically, the error terms of the device arrangement do not change or change only insignificantly over time. The calibration of the device arrangement described above can therefore be carried out once by the manufacturer of the device arrangement. The error terms determined can be stored on the permanent storage medium and made available to a customer in this way. Now if the customer wishes to carry out measurements on a device under test in the device arrangement, the error terms can simply be read out from the permanent storage medium and thus be taken into account in the measurements.

The error terms may be determined individually for each device arrangement and saved in the permanent storage medium. This ensures that precise error terms are determined for each device arrangement. But it is also conceivable that the error terms are determined once for a class of device arrangements of identical construction, which considerably reduces the calibration effort.

In an embodiment, the permanent storage medium may be any suitable non-volatile memory.

According to one aspect of the disclosure, the VNA includes, for example, a data interface which is connected to the permanent storage medium, the error terms determined being transferred from the VNA to the permanent storage medium. In other words, the error terms determined by the VNA can be automatically stored in the permanent storage medium by the VNA, more specifically by the data interface.

According to a further aspect of the disclosure, the device arrangement includes, for example, a plurality of first connection circuits, wherein the error terms are each determined for the plurality of first connection circuits. Alternatively or additionally, the device arrangement includes a plurality of second connection circuits, wherein the error terms are each determined for the plurality of second connection circuits. The error terms for the various first connection circuits and/or the various second connection circuits may all be stored in the permanent storage medium.

Accordingly, when measurements are made on a device under test in the device arrangement, the appropriate data set, i.e. the appropriate error terms, can simply be retrieved for the connection circuits used. This allows measurements to be carried out in a simple manner with different connection circuits without the device arrangement requiring recalibration.

One or more embodiments of the method may include any one or more of the following actions in any combination:
connecting a device under test to the second connector of the first connection circuit and to the first connector of the second connection circuit;
generating a test signal by the VNA and outputting the test signal through the first VNA connector and/or through the second VNA connector;
measuring a signal obtained from the first VNA connector and/or from the second VNA connector; and
determining at least one transmission and/or reflection parameter of the device under test based on the signal measured and based on the error terms determined.

In other words, the transmission and/or reflection parameters of the device under test are determined taking into account the already determined error terms of the device arrangement based on further measurements carried out on the device under test. By taking into account the error terms of the device arrangement, the accuracy of the transmission and/or reflection parameters determined is improved.

The object is further achieved according to the disclosure by a measuring arrangement including a vector network analyzer and a device arrangement. The VNA includes a first VNA connector and a second VNA connector. The device arrangement includes a first connection circuit and a second connection circuit, the first connection circuit and the second connection circuit each including a first connector and a second connector. The first connection circuit and the second connection circuit each have a negligible reverse transmission. The measuring arrangement is configured to carry out at least actions (d) to (i) of the method described above.

In an embodiment, the measuring arrangement is configured to perform all actions that relate to generating, passing on and analyzing signals.

Method actions that relate to a change in the cabling of the measuring arrangement can be carried out by a person.

With regard to the advantages and further characteristics of the measuring arrangement, reference is made to the above discussions with respect to the method, which equally apply to the measuring arrangement, and vice versa.

The object is further achieved according to the disclosure by a permanent storage medium. The permanent storage medium includes a database with error terms, wherein the error terms describe a signal transmission behavior of a device arrangement. The device arrangement includes a first connection circuit and a second connection circuit, the first connection circuit and the second connection circuit each including a first connector and a second connector. The error terms result based on a linear error term model, wherein in the linear error term model a respective reverse transmission of the first connection circuit and the second connection circuit are set equal to zero.

In an embodiment, the error terms can be determined by a method as described above.

In other words, the error terms can be obtained by a method as described above.

The permanent storage medium according to the disclosure allows the error terms for the device arrangement to be determined once and stored or saved in the permanent storage medium. For example, the calibration, that is, the determination of the error terms, can be carried out once by the manufacturer of the device arrangement. The error terms are saved in the permanent storage medium and may, accordingly, be easily made available to a customer.

For example, the permanent storage medium is integrated in the device arrangement. However, the permanent storage medium may also be provided separately from the device arrangement and may also be made available to the customer separately.

With regard to further advantages and characteristics of the permanent storage medium, reference is made to the discussions above with respect to the method, which likewise apply to the permanent storage medium and vice versa.

In an embodiment, the permanent storage medium may be any suitable non-volatile storage device. The permanent storage medium may include, for example, flash memory (e.g., a USB stick, an SD card, etc.), cloud storage, etc.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a measuring arrangement according to an embodiment of the disclosure;

FIG. 2 shows an example device arrangement of the measuring arrangement of FIG. 1;

FIG. 3 shows an example of a flow chart of a method according to an embodiment of the disclosure;

FIG. 4 shows an example linear error term model of the measuring arrangement FIG. 1; and

FIG. 5 shows an example adjusted linear error term model of the measuring arrangement of FIG. 1.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

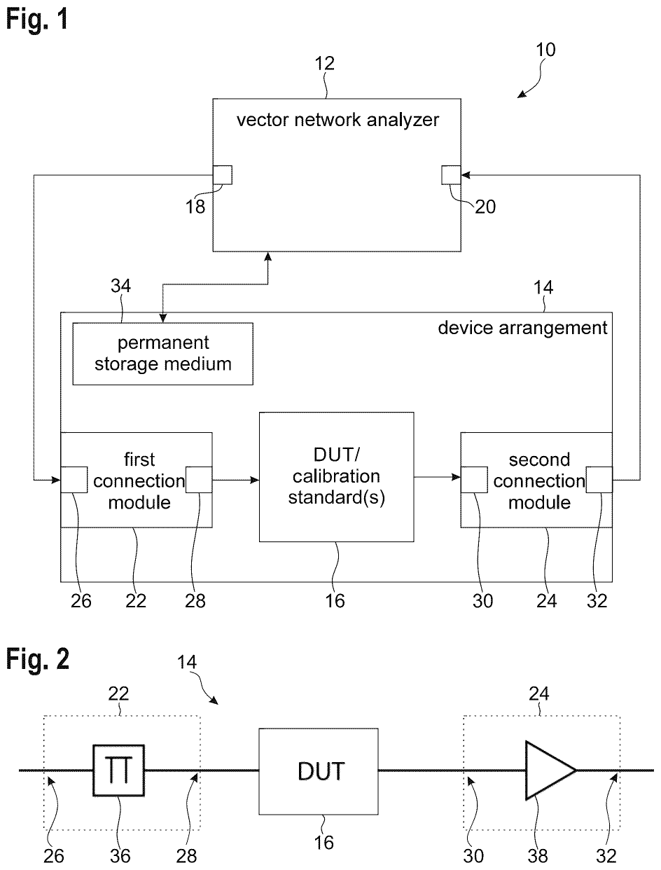

FIG. 1 schematically shows a measuring arrangement 10 having a vector network analyzer (VNA) 12 and a device arrangement 14. In general terms, the measuring arrangement 10 is configured to perform measurements on a device under test (DUT) 16 by the VNA 12. The device arrangement 14 provides an electrical connection between the VNA 12 and the device under test 16.

In the embodiment shown, the VNA 12 includes a first VNA connector 18 and a second VNA connector 20. The first VNA connector 18 is connected to a first connection circuit 22 of the device arrangement 14, for example by a suitable cable. The second VNA connector 20 is connected to a second connection circuit 24 of the device arrangement 14, for example by a suitable cable.

In that regard, the first connection circuit 22 includes a first connector 26 and a second connector 28. The first connector 26 is connected to the first VNA connector 18 and the second connector 28 is connected to the device under test 16. Further components may be provided between the first VNA connector 18 and the first connector 26 of the first connection circuit 22, for example at least one amplifier, a switching matrix, a splitter, or other suitable RF components. The at least one amplifier may be, for example, a low-noise amplifier.

The second connection circuit 24 includes a first connector 30 and a second connector 32. The first connector 30 is connected to the device under test 16 and the second connector 32 is connected to the second VNA connector 20. Further components may be provided between the second VNA connector 20 and the second connector 32 of the second connection circuit 24, for example at least one amplifier, a switching matrix, a splitter, or other suitable RF components. The at least one amplifier may, for example, be a low-noise amplifier.

In the embodiment shown, the measuring arrangement 10 may further comprise a permanent storage medium 34, which can be connected to the VNA 12 by an appropriate data interface. In the example embodiment shown in FIG. 1, the permanent storage medium 34 is integrated in the device arrangement 14. For example, the device arrangement 14 has a housing, with the permanent storage medium 34 being attached to the housing. Here, the permanent storage medium 34 may be arranged inside or outside the housing. The permanent storage medium 34 may be also formed separately from the device arrangement 14.

As already mentioned, the device arrangement 14 is configured to pass electrical signals on to the device under test 16, more specifically by the first connection circuit 22. Furthermore, the device arrangement 14 is configured to pass on electrical signals from the device under test 16, more specifically by the second connection circuit 24. For example, the device arrangement 14 is a cryostat, with the first connection circuit 22 comprising lead-in wires to the device under test 16, while the second connection circuit 24 comprises lead-out wires from the device under test 16. In this case, the device under test 16 may be a quantum computer chip, for example.

FIG. 2 shows an example configuration of the device arrangement 14 in the case that the device arrangement 14 is or comprises a cryostat. The first connection circuit 22 here includes an attenuation arrangement 36 that is configured to attenuate a forward traveling signal, that is, a signal that moves toward the device under test 16.

Typically, the attenuation provided by the attenuation arrangement 36 is selected such that an energy input into the cryostat is minimized. For example, the attenuation may be more than 75 dB or more than 80 dB. In an embodiment, the attenuation is greater than half the dynamic range of the VNA 12.

A signal originating from the VNA 12 and passing through the first connection circuit 22 first in the forward direction and then in the reverse direction is thus very strongly attenuated, for example such that the respective signal disappears in the background noise and can no longer be analyzed by the VNA 12.

The second connection circuit 24 includes an amplifier arrangement 38 that is configured to amplify a forward traveling signal, that is, a signal that moves away from the device under test 16. The amplifier arrangement 38 includes, for example, one or more cascaded amplifiers, for example one or more cascaded low-noise amplifiers.

In an embodiment, the amplifier arrangement 38 is configured to amplify only forward traveling signals, whereas backward traveling signals remain unamplified. Signals that move from the second connector 32 of the second connection circuit 24 toward the device under test 16 are thus not amplified.

The amplifier arrangement 38 may further comprise at least one isolator which allows signal propagation only in the forward direction. In an embodiment, the amplifier arrangement may comprise a plurality of cascaded isolators which allow signal propagation only in the forward direction. The first connection circuit 22 and the second connection circuit 24 thus each have negligible reverse transmission.

According to a further example embodiment of the device arrangement 14, the first connection circuit 22 may include an amplifier arrangement having one or more high-power amplifiers, while the second connection circuit 24 comprises an amplifier arrangement having one or more amplifiers, for example one or more low-noise amplifiers. The first connection circuit 22 and the second connection circuit 24 here also each have negligible reverse transmission. In this example embodiment, however, the device arrangement 14 does not usually comprise a cryostat.

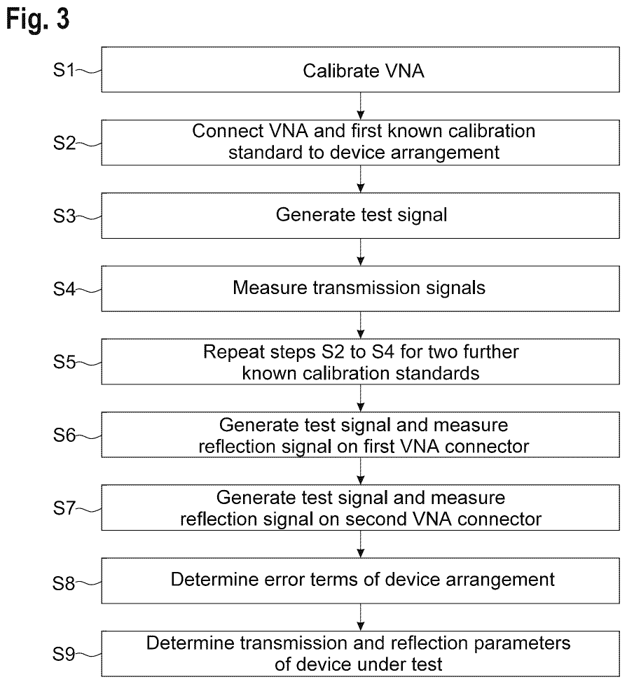

The measuring arrangement 10 is configured to carry out a method of determining error terms of the device arrangement 14, an example of which is described below with reference to FIG. 3. More precisely, the measuring arrangement 10 is configured to carry out the method steps or actions described below, which relate to the generating, passing on and analyzing of signals.

Insofar as the actions described relate to a change in the cabling of the measuring arrangement 10, these actions can be carried out by a human. It is, however, also conceivable for these actions to be carried out automatically by a robot.

In the following, it is assumed, without loss of generality, that the device arrangement 14 involved is a cryostat. The method steps or actions described May however, equally be applied to other device arrangements 14 having a first connection circuit 22 and a second connection circuit 24 that exhibit negligible reverse transmission.

Optionally, first the VNA 12 is calibrated, with the device arrangement 14 not connected to the VNA 12 (step S1).

Calibration of the VNA 12 may be performed using any suitable calibration method, for example by a UOSM method and/or a TRL method.

The VNA 12 is connected to the device arrangement 14 and a first known calibration standard is connected inside the device arrangement to the first connection circuit 22 and to the second connection circuit 24 (step S2).

The first VNA connector 18 is connected to the first connector 26 of the first connection circuit 22. The second VNA connector 20 is connected to the second connector 32 of the second connection circuit 24. The first known calibration standard is connected to the second connector 28 of the first connection circuit 22 and to the first connector 30 of the second connection circuit 24. The first known calibration standard may be, for example, a piece of line of a defined length and defined cross-section, the transmission and reflection properties of which are known.

After the first known calibration standard has been connected to the connection circuits 22, 24, one can first wait until a thermal equilibrium is reached in the cryostat.

A test signal is generated by the VNA 12 and is output via the first VNA connector 18 (step S3).

The test signal generated by the VNA 12 travels through the first connection circuit 22, the first known calibration standard, and the second connection circuit 24 and is received by the second VNA connector 20. A frequency of the test signal(s) generated may be varied here, for example over a predefined frequency range. For example, the frequency is varied continuously or in predetermined steps over the predefined frequency range, which is also referred to as a frequency sweep.

The respective transmission signal is measured by the VNA 12, resulting in measurement data being obtained (step S4).

Steps or actions S3 and S4 are repeated for two further known calibration standards (step S5). In other words, steps or actions S3 and S4 are thus repeated for a second known calibration standard and for a third known calibration standard.

According to an embodiment, three calibration standards that are different from each other may be used here. For example, the three known calibration standards may be three different pieces of line. In an embodiment, the three different pieces of line have different lengths and/or different cross-sections.

According to another embodiment, the first known calibration standard and the second calibration standard may be the same calibration standard. However, the second calibration standard is used in a reverse installation direction. The third known calibration standard is different from the first known calibration standard and from the second known calibration standard.

According to another embodiment, the first known calibration standard and the second known calibration standard are the same calibration standard. However, the second calibration standard is used in a reverse installation direction. The third known calibration standard corresponds to a series connection of two first calibration standards of identical construction.

A test signal is generated by the VNA 12, is output through the first VNA connector 18, and a reflection signal obtained from the first VNA connector is measured, resulting in measurement data being obtained (step S6).

This step or action may be performed, for example, while the first known calibration standard, the second known calibration standard or the third known calibration standard is in the installed state.

Here, the frequency of the test signal or signals generated can be varied, for example over the predefined frequency range.

In addition, a test signal is generated by the VNA 12, is output through the second VNA connector 20, and a reflection signal obtained from the second VNA connector 20 is measured, resulting in measurement data being obtained (step S7).

This step or action may be performed, for example, while the first known calibration standard, the second known calibration standard or the third known calibration standard is in the installed state.

Here, the frequency of the test signal or signals generated can be varied, for example over the predefined frequency range.

Based on the signals measured and/or based on the measurement data obtained, error terms of the device arrangement 14 are determined by the VNA 12 (step S8).

In an embodiment, the error terms are determined based on a linear error term model. The error term model describes transmission and reflection characteristics of the device arrangement 14. Furthermore, the error term model can also describe transmission and reflection characteristics of the VNA 12.

In the following, an example error term model will be described which can be used for the method described above. It will be appreciated, however, that any other suitable error term model may also be used.

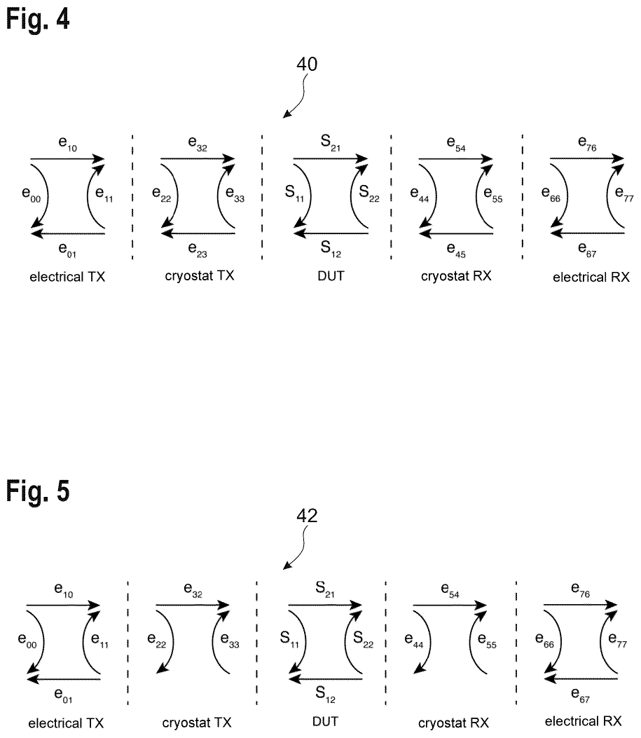

FIG. 4 shows an example of an error term model 40 which comprises error terms et for the VNA 12 and for the device arrangement 14, namely for the example according to which the device arrangement 14 is, or comprises, a cryostat. For example, the error term model 40 comprises error terms et for a transmit path of the VNA 12 (“electrical TX”), for a transmit path of the device arrangement 14 (“cryostat TX”), for a receive path of the device arrangement 14 (“cryostat RX”), and for a receive path of the VNA 12 (“electrical RX”). Moreover, the error term model 40 describes the transmission and reflection characteristics of the device under test 16 (“DUT”).

In the present example, the transmission and reflection characteristics of the device under test 16 are described by the S-parameters of the device under test 16.

In detail, the transmit path of the VNA 12, the transmit path of the device arrangement 14, the device under test 16, the receive path of the device arrangement 14, and the receive path of the VNA 12 are described by the following matrices:

$${\underline{\underline{{E}_{T}}}}_{X} = ( \begin{matrix}{e}_{00} & {e}_{01} \\ {e}_{10} & {e}_{11}\end{matrix} ) , \\ {\underline{\underline{{E}_{KT}}}}_{X} = ( \begin{matrix}{e}_{22} & {e}_{23} \\ {e}_{32} & {e}_{33}\end{matrix} ) , \\ {\underline{\underline{{S}_{DU}}}}_{T} = ( \begin{matrix}{S}_{11} & {S}_{12} \\ {S}_{21} & {S}_{22}\end{matrix} ) , \\ {\underline{\underline{{E}_{KR}}}}_{X} = ( \begin{matrix}{e}_{44} & {e}_{45} \\ {e}_{54} & {e}_{55}\end{matrix} ) , \\ {\underline{\underline{{E}_{KR}}}}_{X} = ( \begin{matrix}{e}_{66} & {e}_{67} \\ {e}_{76} & {e}_{77}\end{matrix} ) ,$$

For determining the error terms of the device arrangement 14, the linear error term model of FIG. 4 is adjusted in that the error terms describing a reverse transmission of the first connection circuit 22 and the second connection circuit 24 are set equal to zero.

In the example of the error term model shown in FIG. 4, the error terms e₂₃ and e₄₅ are thus set equal to zero, resulting in the adjusted linear error term model 42 shown in FIG. 5 being obtained.

The adjusted linear error term model 42 results in the T-matrix of the forward measurement as follows:

$$\underline{\underline{{T}^{f}}} = {( {\underline{\underline{{T}_{T}}}}_{X} \cdot {\underline{\underline{{T}_{KT}}}}_{X} \cdot {\underline{\underline{{T}_{DU}}}}_{T} \cdot {\underline{\underline{{T}_{KR}}}}_{X} \cdot {\underline{\underline{{T}_{R}}}}_{X} )}^{* - 1} .$$

The mapping “*⁻¹” here is defined by

$${\underline{\underline{T}}}^{* - 1} : Mat ( 2 , ℂ ) \to Mat ( 2 , ℂ ) , \underline{\underline{T}} ↦ \frac{1}{det \underline{\underline{T}}} ( \begin{matrix}{T}_{11} & - {T}_{21} \\ - {T}_{12} & {T}_{22}\end{matrix} ) .$$

The measured S-parameters can be determined from this T-matrix, wherein the limit approaching zero is taken for each of the error terms e₂₃ and e₄₅. The measured S-parameters result as follows:

$${S}_{11}^{meas} = {e}_{00} + \frac{{e}_{01} {e}_{10} {e}_{22}}{1 - {e}_{11} {e}_{22}} , \\ {S}_{12}^{meas} = 0 , \\ {S}_{21}^{meas} = \frac{{e}_{10} {e}_{32} {e}_{54} {e}_{76}}{( 1 - {e}_{11} {e}_{22} ) \cdot ( 1 - {e}_{55} {e}_{66} )} \cdot \frac{{S}_{21}}{1 - {e}_{33} {S}_{11} - {e}_{44} {S}_{22} + {e}_{33} {e}_{44} ( {S}_{11} {S}_{22} ) - {S}_{12} {S}_{21} )} . \\ {S}_{22}^{meas} = {e}_{77} + \frac{{e}_{67} {e}_{76} {e}_{55}}{1 - {e}_{66} {e}_{55}} .$$

Here, the

$${S}_{i j}^{meas}$$

correspond to the unmeasured S-parameters of the measuring arrangement 10, that is, the measured S-parameters of the entire transmission path.

The error terms of the transmit path of the VNA 12 (E_{TX}) and of the receive path of the VNA 12 (E_{RX}) may be determined by calibration of the VNA 12 as described in step S1.

This means that from the error model described above, only the error terms e₃₂·e₅₄, e₃₃ and e₄₄ still remain to be determined.

These three error terms are determined based on the measurements made on the three known calibration standards.

Let the S-parameters of the first known calibration standard be given by

$$\underline{\underline{{S}_{T}}} = ( \begin{matrix}{T}_{11} & {T}_{12} \\ {T}_{21} & {T}_{22} ,\end{matrix} )$$

The second known calibration standard is described below by primed quantities and the third known calibration standard is described by double primed quantities.

For the measurements on the known calibration standards, the following then results:

$$\begin{matrix}{e}_{22} = \frac{{S}_{11}^{meas} - {e}_{00}}{{e}_{11} ( {S}_{11}^{meas} - {e}_{00} ) + {e}_{01} {e}_{10}} \\ = \frac{{S}_{11}^{′ meas} - {e}_{00}}{{e}_{11} ( {S}_{11}^{′ meas} - {e}_{00} ) + {e}_{01} {e}_{10}} \\ = \frac{{S}_{11}^{″ meas} - {e}_{00}}{{e}_{11} ( {S}_{11}^{″ meas} - {e}_{00} ) + {e}_{01} {e}_{10}} ,\end{matrix} \\ \begin{matrix}{e}_{55} = \frac{{S}_{22}^{meas} - {e}_{77}}{{e}_{66} ( {S}_{22}^{meas} - {e}_{77} ) + {e}_{67} {e}_{76}} \\ = \frac{{S}_{22}^{′ meas} - {e}_{77}}{{e}_{66} ( {S}_{22}^{′ meas} - {e}_{77} ) + {e}_{67} {e}_{76}} \\ = \frac{{S}_{22}^{″ meas} - {e}_{77}}{{e}_{66} ( {S}_{22}^{″ meas} - {e}_{77} ) + {e}_{67} {e}_{76}} .\end{matrix}$$

For determining the remaining error terms, the following system of equations has to be solved:

$${S}_{21}^{meas} = γ \cdot \frac{{T}_{21}}{1 - {e}_{33} {T}_{11} - {e}_{44} {T}_{22} + {e}_{33} {e}_{44} δ} , \\ {S}_{21}^{′ meas} = γ \cdot \frac{{T}_{21}^{′}}{1 - {e}_{33} {T}_{11}^{′} - {e}_{44} {T}_{22}^{′} + {e}_{33} {e}_{44} {δ}^{′}} , \\ {S}_{21}^{″ meas} = γ \cdot \frac{{T}_{21}^{″}}{1 - {e}_{33} {T}_{11}^{″} - {e}_{44} {T}_{22}^{″} + {e}_{33} {e}_{44} {δ}^{″}} ,$$

The following substitutions were made here:

$$γ = \frac{{e}_{10} {e}_{32} {e}_{54} {e}_{76}}{( 1 - {e}_{11} {e}_{22} ) \cdot ( 1 - {e}_{55} {e}_{66} )} , \\ δ = {T}_{11} {T}_{22} - {T}_{12} {T}_{21} , \\ {δ}^{′} = {T}_{11}^{′} {T}_{22}^{′} - {T}_{12}^{′} {T}_{21}^{′} , \\ {δ}^{″} = {T}_{11}^{″} {T}_{22}^{″} - {T}_{12}^{″} {T}_{21}^{″}$$

The system of equations can be solved numerically and/or analytically.

It may be necessary here to select the solution from two different solution branches. In an embodiment, the solution branch may be selected according to physical aspects.

If three different calibration standards are not used, but calibration standards according to the second or third embodiments described above, the system of equations to be solved is reduced to

$${S}_{21}^{meas} = γ \cdot \frac{{T}_{21}}{1 - {e}_{33} {T}_{11} - {e}_{44} {T}_{22} + {e}_{33} {e}_{44} Δ} , \\ {S}_{21}^{′ meas} = γ \cdot \frac{{T}_{21}}{1 - {e}_{33} {T}_{22} - {e}_{44} {T}_{11} + {e}_{33} {e}_{44} Δ} , \\ {S}_{21}^{″ meas} = γ \cdot \frac{{T}_{21}^{″}}{1 - {e}_{33} {T}_{11}^{″} - {e}_{44} {T}_{22}^{″} + {e}_{33} {e}_{44} {Δ}^{″}} ,$$

where the following substitutions were used:

$$γ = \frac{{e}_{10} {e}_{32} {e}_{54} {e}_{76}}{( 1 - {e}_{11} {e}_{22} ) \cdot ( 1 - {e}_{55} {e}_{66} )} , \\ Δ = {T}_{11} {T}_{22} - {T}_{21}^{2} , \\ {Δ}^{″} = {T}_{11}^{″} {T}_{22}^{″} - {T}_{21}^{″2}$$

If the third embodiment described above is used, i.e. a cascading of two first known calibration standards, which results in the third known calibration standard, the T-matrix of the third calibration standard can be expressed by the first calibration standard, namely as:

$$\underline{\underline{{T}^{″}}} = \frac{1}{1 - {T}_{11} {T}_{22}} \cdot ( \begin{matrix}{T}_{11} ( 1 - {T}_{11} {T}_{22} - {T}_{21}^{2} ) & {T}_{21}^{2} \\ {T}_{21}^{2} & {T}_{22} ( 1 - {T}_{11} {T}_{22} - {T}_{21}^{2} )\end{matrix} ) .$$

The error terms of the device arrangement 14 as determined in accordance with the steps described above may be stored in the permanent storage medium 34.

For example, the VNA 12 may comprise a suitable data interface, which is connected to the permanent storage medium 34. The error terms determined by the VNA 12 can then be saved or stored in the permanent storage medium 34 by the data interface.

It will be appreciated that the device arrangement 14 may include a plurality of first connection circuits 22 and/or a plurality of second connection circuits 24.

In an embodiment, the error terms may be determined for each of the various first connection circuits 22 and/or the various second connection circuits 24.

Based on the error terms of the device arrangement 14 as determined, transmission and/or reflection parameters of the device under test 16 can be determined (step S9).

To this end, the device under test 16 is connected to the second connector 28 of the first connection circuit 22 and to the first connector 30 of the second connection circuit 24. A test signal is now generated by the VNA 12 and is output through the first VNA connector 18 and/or through the second VNA connector 20. The respective signal obtained from the first VNA connector 18 and/or from the second VNA connector 20 is measured. Based on the signals measured and also based on the error terms of the device arrangement 14 already determined, the transmission and/or reflection parameters of the device under test 16 are then determined.

It may be necessary here that further information about the transmission and/or reflection parameters of the device under test 16 is already available and/or is determined by a simulation, for example.

In an embodiment, it may be necessary that individual S-parameters of the device under test 16 are already known, that assumptions are made about individual S-parameters of the device under test 16, and/or that individual S-parameters of the device under test 16 are determined by a simulation.

It is also possible, for example, to carry out sensitivity analyses and to determine a prediction range or an uncertainty range for measurement results by numerical simulation of the S-parameters.

The S-parameters of the device under test 16 result as follows:

$${S}_{11} = \frac{1}{{e}_{33} ( 1 - {e}_{44} {S}_{22} )} \cdot ( 1 - γ \cdot \frac{{S}_{21}}{{S}_{21}^{meas}} - {e}_{44} {S}_{22} - {e}_{33} {e}_{44} {S}_{12} {S}_{21} ) \\ {S}_{12} = \frac{1}{{e}_{33} {e}_{44}} \cdot ( \frac{( 1 - {e}_{33} {S}_{11} ) \cdot ( 1 - {e}_{44} {S}_{22} )}{{S}_{21}} \cdot \frac{γ}{{S}_{21}^{meas}} ) , \\ {S}_{21} = \frac{( 1 - {e}_{33} {S}_{11} ) \cdot ( 1 - {e}_{44} {S}_{22} )}{{e}_{33} {e}_{44} {S}_{12} + γ / {S}_{21}^{meas}} , \\ {S}_{22} = \frac{1}{{e}_{44} ( 1 - {e}_{32} {S}_{11} )} \cdot ( 1 - γ \cdot \frac{{S}_{21}}{{S}_{21}^{meas}} - {e}_{33} {S}_{11} - {e}_{33} {e}_{44} {S}_{12} {S}_{21} )$$

If the device under test 16 is reciprocal, this result is reduced to:

$${S}_{11} = \frac{1}{{e}_{33} ( 1 - {e}_{44} {S}_{22} )} \cdot ( 1 - γ \cdot \frac{{S}_{21}}{{S}_{21}^{meas}} - {e}_{44} {S}_{22} - {e}_{33} {e}_{44} {S}_{21}^{2} ) , \\ {S}_{12} = {S}_{21} , \\ {S}_{21} = \frac{γ}{2 {e}_{33} {e}_{44} {S}_{21}^{meas}} \pm \sqrt{\frac{( 1 - {e}_{33} {S}_{11} ) \cdot ( 1 - {e}_{44} {S}_{22} )}{{e}_{33} {e}_{44}} + {( \frac{γ}{2 {e}_{33} {e}_{44} {S}_{21}^{meas}} )}^{2}} , \\ {S}_{22} = \frac{1}{{e}_{44} ( 1 - {e}_{33} {S}_{11} )} \cdot ( 1 - γ \cdot \frac{{S}_{21}}{{S}_{21}^{meas}} - {e}_{33} {S}_{11} - {e}_{33} {e}_{44} {S}_{21}^{2} ) .$$

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be used synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the measuring arrangement 10 etc., referenced above include circuitry programmed to carry out one or more actions or steps of any of the methods disclosed herein. In an embodiment, one or more computer-readable media associated with or accessible by such circuitry contains computer readable instructions embodied thereon that, when executed by such circuitry, cause the component or circuitry to perform one or more steps or actions of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the disclosure in which an exclusive property or privilege is claimed are defined as follows:

1. A method of determining error terms of a device arrangement by a vector network analyzer (VNA), the VNA including a first VNA connector and a second VNA connector and the device arrangement including a first connection circuit and a second connection circuit, the first connection circuit and the second connection circuit each including a first connector and a second connector, wherein the first connection circuit and the second connection circuit each have negligible reverse transmission, the method comprises:
(a) connecting the first connector of the first connection circuit to the first VNA connector;
(b) connecting the second connector of the second connection circuit to the second VNA connector;
(c) connecting a known first calibration standard to the second connector of the first connection circuit and to the first connector of the second connection circuit;
(d) generating a test signal by the VNA and outputting the test signal through the first VNA connector;
(e) measuring a transmission signal obtained from the second VNA connector;
(f) repeating steps (c) to (e) for two further known calibration standards;
(g) generating a test signal by the VNA, outputting the test signal through the first VNA connector, and measuring a reflection signal obtained from the first VNA connector;
(h) generating a test signal by the VNA, outputting the test signal through the second VNA connector, and measuring a reflection signal obtained from the second VNA connector; and
(i) determining error terms of the device arrangement based on the signals measured, the error terms describing a signal transmission behavior of the device arrangement.

2. The method according to claim 1, wherein a frequency of the generated test signal or signals is varied.

3. The method according to claim 1, wherein the error terms are determined based on a linear error term model, wherein in the linear error term model a respective reverse transmission of the first connection circuit and the second connection circuit are set equal to zero.

4. The method according to claim 1, wherein the first connection circuit comprises an amplifier arrangement, the amplifier arrangement being configured to amplify signals from the first connector toward the second connector.

5. The method according to claim 4, wherein the amplifier arrangement includes at least one of an high-power amplifier, a low-noise amplifier, or at least one isolator.

6. The method according to claim 1, wherein the first connection circuit includes an attenuation arrangement, an attenuation provided by the attenuation arrangement being greater than half the dynamic range of the VNA.

7. The method according to any of the preceding claims, wherein the second connection circuit comprises an amplifier arrangement, the amplifier arrangement being configured to amplify signals from the first connector toward the second connector.

8. The method according to claim 7, wherein the amplifier arrangement includes an amplifier.

9. The method according to claim 7, wherein the amplifier arrangement includes at least one low-noise amplifier.

10. The method according to claim 7, wherein the amplifier arrangement includes at least one isolator.

11. The method according to claim 1, wherein the three known calibration standards are different from each other.

12. The method according to claim 1, wherein the second known calibration standard corresponds to the first calibration standard in a reverse mounting direction and the third known calibration standard is different from the first calibration standard and from the second calibration standard, or
wherein the second known calibration standard corresponds to the first calibration standard in a reverse mounting direction and the third known calibration standard corresponds to a series connection of two first known calibration standards.

13. The method according to claim 1, wherein the device arrangement comprises a cryostat, the first connection circuit and the second connection circuit being arranged within the cryostat.

14. The method according to claim 13, wherein the known calibration standards are connected inside the cryostat to the second connector of the first connection circuit and to the first connector of the second connection circuit.

15. The method according to claim 1, wherein the device arrangement includes a permanent storage medium, the error terms determined being saved in the permanent storage medium.

16. The method according to claim 15, wherein the VNA includes a data interface which is connected with the permanent storage medium, and wherein the error terms determined are transferred from the VNA to the permanent storage medium.

17. The method according to claim 1, wherein the device arrangement includes a plurality of first connection circuits, wherein the error terms are each determined for the plurality of first connection circuits,
and/or wherein the device arrangement includes a plurality of second connection circuits, wherein the error terms are each determined for the plurality of second connection circuits.

18. The method according to claim 1, further comprising:
connecting a device under test to the second connector of the first connection circuit and to the first connector of the second connection circuit;
generating a test signal by the VNA and outputting the test signal through the first VNA connector and/or through the second VNA connector;
measuring a signal obtained from the first VNA connector and/or from the second VNA connector; and
determining at least one transmission and/or reflection parameter of the device under test based on the signal measured and based on the error terms determined.

19. A measuring arrangement comprising a vector network analyzer and a device arrangement, wherein the VNA includes a first VNA connector and a second VNA connector and the device arrangement includes a first connection circuit and a second connection circuit, the first connection circuit and the second connection circuit each including a first connector and a second connector, wherein the first connection circuit and the second connection circuit each have negligible reverse transmission, and wherein the measuring arrangement is configured to carry out at least steps (d) to (i) of the method according to claim 1.

20. A permanent storage medium, wherein the permanent storage medium comprises a database with error terms, the error terms describing a signal transmission behavior of a device arrangement, wherein the device arrangement includes a first connection circuit and a second connection circuit, the first connection circuit and the second connection circuit each including a first connector and a second connector, and wherein the error terms result based on a linear error term model, wherein in the linear error term model a respective reverse transmission of the first connection circuit and the second connection circuit are set equal to zero.
